(19) United States
(12) Patent Application Publication
(10) Pub. No.: US 2023/0099153 A1
(43) Pub. Date: Mar. 30, 2023

(54) RISK-BASED AGGREGATE DEVICE REMEDIATION RECOMMENDATIONS BASED ON DIGITIZED KNOWLEDGE

(71) Applicant: Cisco Technology, Inc., San Jose, CA (US)

(72) Inventors: Donald Mark Allen, Colorado Springs, CO (US); Dmitry Goloubev, Waterloo (BE)

(21) Appl. No.: 17/490,349

(22) Filed: Sep. 30, 2021

(51) Int. Cl. G06Q 10/06; G06Q 10/00; G06F 8/65; H04L 29/06; H04L 12/24

(52) U.S. Cl. CPC G06Q 10/06375; G06Q 10/20; G06Q 10/06313; G06F 8/65; H04L 63/20; H04L 41/14; H04L 41/0816; G06Q 10/0635

(57) ABSTRACT

Methods are provided in which a computing device obtains telemetry data associated with an enterprise network that includes a plurality of assets involved in providing one or more enterprise services, obtains available software upgrade information, and generates at least two remediation plans based on the telemetry data and the available software upgrade information. Each of the at least two remediation plans being directed to a change in a configuration of one or more assets of the plurality of assets. The methods further include computing a probability of success of each of the at least two remediation plans based on the telemetry data and the available software upgrade information and providing the at least two remediation plans with a respective probability of success.

### TECHNICAL FIELD

The present disclosure relates to computer networks and systems.

### BACKGROUND

Enterprise device and network operating system upgrades and migrations are complex tasks. Network devices, features, and enterprise functions supported by these networks are diverse and vary widely based on a particular network and the enterprise. Many recommendation engines exist that recommend various upgrades or configuration changes to an enterprise but do not account for this disparity of devices, features, and functions. Careful and lengthy assessments and planning are performed by highly skilled network experts to develop and execute upgrades and/or migrations.

### BRIEF DESCRIPTION OF THE DRAWINGS

FIG. 1 is a block diagram of a system that includes an enterprise service cloud that interacts with network/computing equipment and software residing at various enterprise sites and with a remediation and risk assessment engine, according to an example embodiment.

FIG. 2 is a high-level diagram illustrating an architecture for generating various remediation plans with their respective probabilities of success, according to an example embodiment.

FIG. 3 is a user interface screen illustrating remediation plans with respective probabilities of success, according to an example embodiment.

FIG. 4 is a flowchart illustrating a computer-implemented method of providing at least two remediation plans with respective probabilities of success, according to an example embodiment.

FIG. 5 is a hardware block diagram of a computing device that may perform functions associated with any combination of operations in connection with the techniques depicted and described in FIGS. 1-4.

### DESCRIPTION OF EXAMPLE EMBODIMENTS

### Overview

Briefly, methods are presented for generating remediation plans with respective probabilities of success based on attributes of an enterprise network, available software upgrade information, and/or experiences of similarly situated enterprise networks.

In one example, a method is provided that includes obtaining telemetry data associated with an enterprise network that includes a plurality of assets involved in providing one or more enterprise services, obtaining available software upgrade information, and generating at least two remediation plans based on the telemetry data and the available software upgrade information. Each of the at least two remediation plans being directed to a change in a configuration of one or more assets of the plurality of assets. The method further includes computing a probability of success of said each of the at least two remediation plans based on the telemetry data and the available software upgrade information and providing the at least two remediation plans with the respective probability of success.

### Example Embodiments

Diversity of devices, features, and enterprise functions supported by various networks may cause some upgrades and/or migrations to fail. A variety of factors influence the success rate of an upgrade or migration including but not limited to a magnitude of change between the as-is and desired operating system version, the feature configuration of a device, the tools enterprises use to manage the process, network monitoring systems/capabilities, and the skill level of the network operators performing the configuration changes. Maintaining feature parity between software versions can be exacerbated due to known bugs in desired target operating systems that could influence parity and may require workarounds or may not be valid candidates for consideration. Even the most robust enterprise environment is subject to some degree of risk and investment when upgrading. Enterprises need to be aware of the risks and need to be able to assess the risk and investment associated with different upgrade approaches to maintain their network and dependent enterprise systems availability. While various recommendation engines may advise the enterprise and network operators on a best version of software to upgrade the device based on device's exposure to security vulnerabilities, software bugs, field notices, etc., these engines fail to account for other device issues and do not provide information about possible failures that may occur in an enterprise network during the upgrade or migration and especially when executing moderate to large upgrades and migrations in an enterprise network.

Further, multiple software versions are typically available to enterprises when they decide to upgrade or migrate devices in their network. Each software version has benefits and risks that can influence an enterprise's choice and selection. The techniques presented herein obtain and utilize information about the enterprise network, the available software versions, and the previous experience of the enterprise to calculate different remediation plans and determine risk factors to empower enterprises in making their remediation plan decisions.

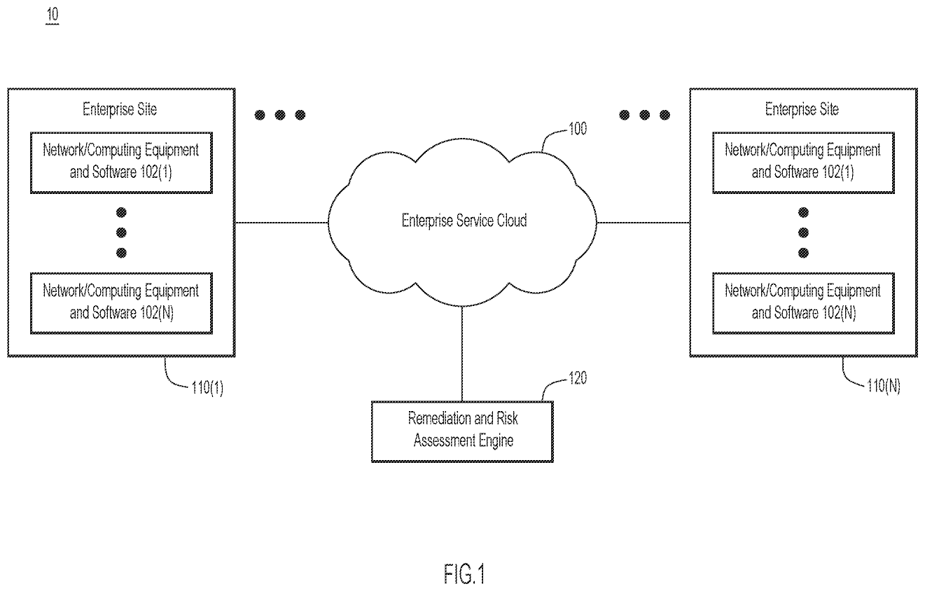

FIG. 1 is a block diagram of a system 10 that includes an enterprise service cloud 100 that interacts with network/computing equipment and software 102(1)-102(N) residing at various enterprise sites 110(1)-110(N), or in cloud deployments of an enterprise and with a remediation and risk assessment engine 120, according to an example embodiment.

The notations 1, 2, 3, . . . n and a, b, c, n illustrate that the number of elements can vary depending on a particular implementation and is not limited to the number of elements depicted being depicted or described.

The network/computing equipment and software 102(1)-102(N) are resources or assets of an enterprise (the terms “assets” and “resources” are used interchangeably herein). The network/computing equipment and software 102(1)-102(N) may include any type of network devices or network nodes such as controllers, access points, gateways, switches, routers, hubs, bridges, gateways, modems, firewalls, intrusion protection devices/software, repeaters, servers, data storage equipment, and so on. The network/computing equipment and software 102(1)-102(N) may further include endpoint or user devices such as a personal computer, laptop, tablet, and so on. The network/computing equipment and software 102(1)-102(N) may include virtual nodes such as virtual machines, containers, point of delivery (PoD), and software such as system software (operating systems), firmware, security software such as firewalls, and other software products. Associated with the network/computing equipment and software 102(1)-102(N) is configuration data representing various configurations, such as enabled and disabled features. The network/computing equipment and software 102(1)-102(N), located at the enterprise sites 110(1)-110(N), represent information technology (IT) environment of an enterprise.

The enterprise sites 110(1)-110(N) may be physical locations such as one or more data centers, facilities, or buildings located across geographic areas that designated to host the network/computing equipment and software 102(1)-102(N). The enterprise sites 110(1)-110(N) may further include one or more virtual data centers, which are a pool or a collection of cloud-based infrastructure resources specifically designed for enterprise needs, and/or for cloud-based service provider needs.

The network/computing equipment and software 102(1)-102(N) may send to the enterprise service cloud 100, via telemetry techniques, data about their operational states and configurations so that the enterprise service cloud 100 is continuously updated about the operational states, configurations, software versions, etc., of each instance of the network/computing equipment and software 102(1)-102(N) of an enterprise.

The enterprise service cloud 100 is driven by human and digital intelligence that serves as a one-stop destination for equipment and software of an enterprise to access insights and expertise when needed. Examples of capabilities include assets and coverage, cases (errors or issues to troubleshoot), automation workbench, insights with respect to detected anomalies and remediation actions, and so on. The enterprise service cloud 100 helps enterprise network technologies to be assessed based on telemetry and contextual learning, support content, expert resources, and analytics and insights. The enterprise service cloud 100 threads data from multiple disparate sources into a contextualized digital representation of the enterprise's IT environment via a portfolio of hardware/software assets and services from one or more providers.

The enterprise service cloud 100 feeds telemetry data associated with an enterprise network to the remediation and risk assessment engine 120. The remediation and risk assessment engine 120 collects information about enterprise assets and the enterprise network based on the telemetry data and collects information about various upgrades and/or migration options (available software upgrade information) to assess the risk of each available upgrade or migration option, as detailed below.

The enterprise service cloud 100 and the remediation and risk assessment engine 120 may be executed by one or more computing devices, such as servers.

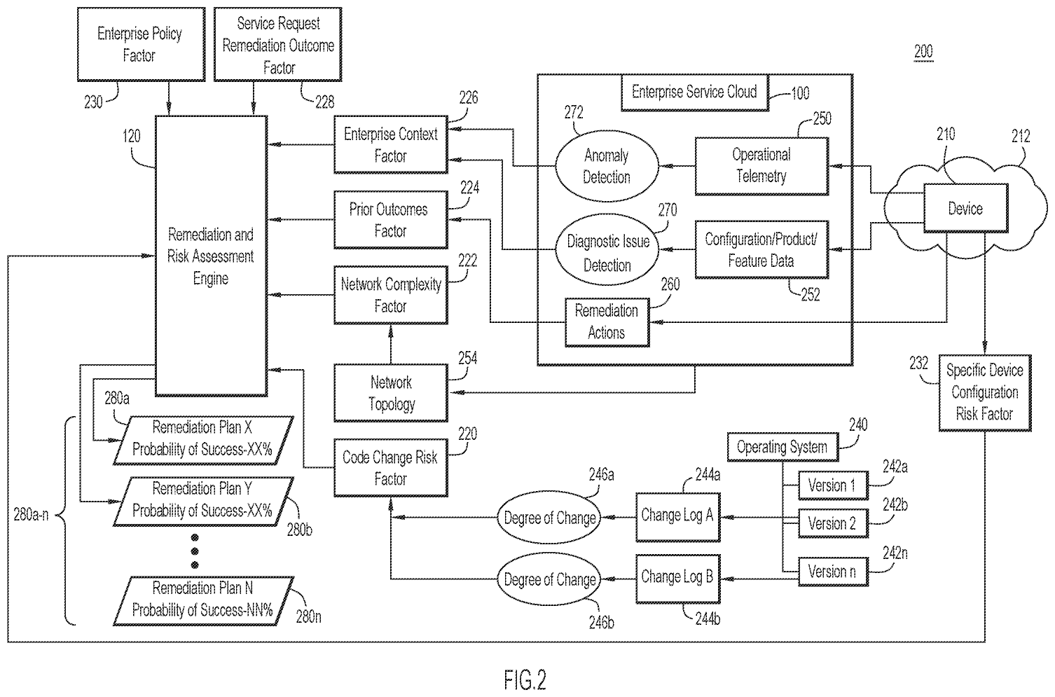

FIG. 2 is a high-level diagram illustrating an architecture 200 for generating various remediation plans with respective probabilities of success, according to an example embodiment. Reference is also made to FIG. 1 for purposes of the description of FIG. 2. The architecture 200 includes the enterprise service enterprise service cloud 100, the remediation and risk assessment engine 120, and a device 210, which is an example of one of the network/computing equipment and software 102(1)-102(N) of FIG. 1. While only one device 210 is depicted in FIG. 2, there are multiple devices (network/computing equipment and software 102(1)-102(N)) and the number of devices depends on a particular deployment of an enterprise network 212.

In an example embodiment, an enterprise is provided with recommendations for upgrading its enterprise network 212, either at the device 210 level (and like devices) or technology solution level, using objective information and heuristic judgements about the enterprise network 212 and its assets (devices and software), configurations in the enterprise network 212 and its assets, the operating system change history, and experiences of other enterprises that have performed similar changes. In addition, the enterprise may develop heuristics for determining what software release candidates should be considered based on past experience, outside influences, etc., when developing recommendations for remediation.

The remediation and risk assessment engine 120 considers various factors including but not limited to context of the enterprise network 212 and the role of the device 210 (assets) in the delivery of network services to support that enterprise when identifying the different remediation plans 280a-n to address device and network issues. The remediation and risk assessment engine 120 utilizes telemetry data and software upgrade information to compute or consider various factors which include but not limited to: (1) code change risk factor 220, (2) network complexity factor 222 of the enterprise network 212, (3) prior outcomes factor 224, (4) enterprise context factor 226, (5) service request remediation outcome factor 228, (6) enterprise policy factor 230, and (7) specific device configuration risk factor 232, to generate the remediation plans 280a-n.

Code Change Risk Factor 220

Software is managed using software repositories, which have integrated change management capabilities such as check-in requirements for identifying the nature and reason for the change. Changes can take the form of code refactoring, a bug fix, a new feature, updated libraries, etc. For example, an operating system 240 may include various versions 242a-n. The change management capabilities of a software repository generate respective change logs for the differences between various versions such as a change log A 244a and a change log B 244b. For example, the change log A 244a includes code changes from version 1 242a to version 2 242b of the operating system 240 and the change log B 244b includes code changes from version 2 242b to version n 242n of the operating system 240.

Based on a current version of software that is running on one or more assets of the enterprise network 212 and an available target update version, the corresponding change log or manifest is retrieved. For example, if the device 210 is currently running version 1 242a and an update to version 2 242b is being considered, the change log A 244a is obtained. Based on the corresponding change log, the remediation and risk assessment engine 120 computes the degree of change such as first degree of change 246a based on the change log A 244a. If the device 210 is currently running version 2 242b and the target update version is version n 242n, the change log B 244b is retrieved and second degree of change 246b is computed.

The first degree of change 246a and the second degree of change 246b indicate how much of the code was changed. For example, when a significant portion of the code changes, this may indicate that it is a major upgrade. On the other hand, if the code changes appear minor, this may indicate a minor upgrade to fix a particular bug. The nature of these updates can have a differential impact on the subsequent software release. Specifically, upgrading to a new major version of a library, significant rework to a critical software component, etc. results in a more bug prone or an unstable release.

In an example embodiment, the remediation and risk assessment engine 120 may compute the code change risk factor 220 based on the first degree of change 246a and the second degree of change 246b. The effects of configuration or code changes are often non-linear and non-monotonous. As such, to quantify the risk related to a change in a configuration of one or more assets of the enterprise network such as a software upgrade to a target release, the code change risk factor 220 is computed as a function of an adoption, a migration, and a median dwell time. Adoption is a fraction of the assets that already deployed the target release. Migration is a rate of departure off the target release. Dwell time is time spent running the target release before performing the migration process.

In one example embodiment, in case of the software upgrade being an in-service software upgrade (ISSU) in which a runtime state is exchanged between two versions, there is an additional factor quantifying the risk of runtime state of source release having a latent corruption or inconsistencies. This risk is quantified as a function of mean of the dwell time of all ISSU upgrades from a given source release.

The remediation and risk assessment engine 120 obtains available software upgrade information that includes data related to nature of, and reason for, the upgrade and may include one or more manifests documenting changes made between various versions of software. The remediation and risk assessment engine 120 determines the current version being executed by a respective asset of the enterprise network 212, determines a degree of code change between the current version and the available target software upgrade, and computes the code change risk factor 220. The code change risk factor 220 helps determine the probability of success of an upgrade.

Network Complexity Factor 222

The network complexity factor 222 is computed based on characteristics of the enterprise network deployment that could impact the probability of a successful change. The remediation and risk assessment engine 120 communicates with the enterprise service cloud 100 to compute the network complexity factor 222. The remediation and risk assessment engine 120 obtains information about the enterprise network 212 using telemetry data that includes operational telemetry data 250 and configuration, product, and feature data 252. Information about the enterprise network 212 may be obtained from the asset inventory available via the enterprise service cloud 100. The information includes the following attributes: network topology information 254, number of different network technologies deployed in the enterprise network 212, and number and types of assets. For example, on a per product family basis, the number of: (1) device families deployed in the enterprise network 212, (2) operating system versions deployed in the enterprise network 212, and (3) deployment architecture. Deployment architecture includes attributes such as no cloud deployments, hybrid single cloud provider, hybrid multi-cloud provider, and cloud-only deployments.

The remediation and risk assessment engine 120 evaluates the complexity of the enterprise network 212 based on the telemetry data including number and types of network technologies affected by an available software update, number and types of assets affected by an available software upgrade, and deployment architecture of the enterprise network 212. Based on the foregoing, the remediation and risk assessment engine 120 computes the network complexity factor 222, which may be represented in a form of a network complexity score.

In one example embodiment, the network complexity factor 222 is a function of the context in which an enterprise is making the change (across 100 devices or a smaller portion of the assets) and the network topology information 254 (particular topology of the enterprise network 212, network technology being affected, etc.). The network complexity factor 222 represents the environment of the configuration change or software upgrade such as how many network devices, which ones are to be affected by the configuration change, and is the same service running similar software.

In one example embodiment, the network complexity factor 222 may include a network resiliency factor. The network resiliency factor is computed based on the presence of the following: high availability deployment (failover), degree of redundancy or over provisioning in the enterprise network 212, and software recovery automation. The network resiliency factor represents robustness of the environment in which the configuration change is to occur. The higher the network resiliency factor, the higher the probability of success of the target upgrade.

Prior Outcomes Factor 224

The prior outcomes factor 224 is computed based on the success rates of prior enterprises that attempted to upgrade a device from the state matching the current enterprise. For example, the analysis may consider other enterprises that attempted to upgrade a device similar to the device 210 to the desired version of the operating system 240. The prior outcomes factor 224 is computed as a function of the total successful configuration changes divided by the total attempted configuration changes. The prior outcomes factor 224 is computed for each of the remediation plans 280a-n being considered if the target version of the operating system 240 is different across the remediation plans 280a-n.

In an example embodiment, the enterprise service cloud 100 monitors the network/computing equipment and software 102(1)-102(N) of various network enterprises and tracks configuration changes made to each of the network/computing equipment and software 102(1)-102(N) of various network enterprises. The enterprise service cloud 100 tracks remediation actions 260 that were performed on one or more of the network/computing equipment and software 102(1)-102(N). The history of the remediation actions 260 with respect to a particular configuration change (or upgrade) performed on devices that are similar to the devices in the upgrade environment of the enterprise network 212 are then evaluated to determine the degree of success of the particular configuration change (or the upgrade).

The remediation and risk assessment engine 120 evaluates success rates of the configuration change performed by other similarly configured enterprise networks to compute the prior outcomes factor 224.

Enterprise Context Factor 226

The enterprise context factor 226 represents the health of the enterprise network 212 and is computed based configuration issues and anomalies that exist in the enterprise network 212.

In one example embodiment, a diagnostic issue detection 270 includes diagnosing configuration issues in the enterprise network 212. The configuration issues may be bugs present in the assets of the enterprise network 212, field notices related to the enterprise network 212, and/or security advisories related to security vulnerabilities in the enterprise network 212. The diagnostic issue detection 270 outputs a configuration issues factor computed based on the total number of configuration issues that have been unresolved and best practice violations present in the enterprise network 212 divided by the total number of configurable devices present in the enterprise network 212.

The anomaly detection 272 includes detecting unexplained anomalies in the enterprise network 212. The unexplained anomalies represent a level of instability of the enterprise network 212. The anomaly detection 272 outputs the anomalies factor computed based on the total number of unexplained anomalies detected within the enterprise network 212 divided by the total number of devices present in the enterprise network 212.

The enterprise context factor 226 is then computed by averaging these two measurements: the configuration issues factor obtained from the diagnostic issue detection 270 and the anomalies factor obtained from the anomaly detection 272.

Service Request Remediation Outcome Factor 228

The service request remediation outcome factor 228, computed by the remediation and risk assessment engine 120, is based on service requests generated by various enterprises with respect to a target upgrade. That is, some enterprises generate service requests when performing the target upgrade or migration for any number of reasons. Service requests may include an open support case to obtain help with performing the upgrade, an incident report reporting an issue with the target upgrade, troubleshooting case, etc. Opened cases and resolution of these cases are then used to compute the service request remediation outcome factor 228.

In one example, the service request remediation outcome factor 228 is calculated based on the service requests related to a software upgrade from a current version to a target version of the operating system 240. The remediation and risk assessment engine 120 determines current version of the operating system 240 in the assets of the enterprise network 212 and a target version being considered for a respective remediation plan and then selects service requests that relate to performing the upgrade from the current version to the target version. The remediation and risk assessment engine 120 analyzes outcomes of the selected service requests and computes the service request remediation outcome factor 228.

The service request remediation outcome factor 228 may further include network prior outcomes factor, which is computed as a function of a mean dwell time of total upgrades performed in a given network over a window of lifetime of a device in question over the mean dwell time of total known upgrades over all networks in the same time period.

Enterprise Policy Factor 230

The enterprise policy factor 230 includes heuristics or a set of rules used to identify potential target versions from the versions 240a-n to upgrade the assets of the enterprise network 212.

For example, the enterprise policy factor 230 may include configuration type rules related to types of configuration changes permitted and/or timing rules related to when to perform the configuration changes. For example, do not upgrade to the X.0.0 major release, wait until at least the first minor release X.1.0. As another example, do not upgrade a release that would cause compatibility issues with end of support devices in X network technology or only upgrade to a release that is recommended by a network provider or an operator responsible for the operating system 240, etc. The enterprise policy factor 230 may further include specific rules for performing upgrades such as all devices of product family series must run the same version of the operating system 240. The enterprise policy factor 230 may further include security rules such as do not upgrade to a release that has known critical security vulnerabilities unless there is an approved workaround.

The remediation and risk assessment engine 120 applies the enterprise policy factor 230 as constraints when evaluating various possible upgrades or migrations such as the versions 242a-n of the operating system 240 to be included in the remediation plans 280a-n.

Specific Device Configuration Risk Factor 232

The specific device configuration risk factor 232 estimates risks related to an upgrade of a particular device hardware and software configuration. The specific device configuration risk factor 232 is estimated by vectorizing (embedding) device hardware and software configurations and searching in the space of known device upgrades for vectors of sufficient similarity. That is, information knowns about the device 210 (its features and configurations) is transformed into a vector form (a string of numbers) using a neural network, for example. This affected network device vector is compared to other vectors that represent known devices. Other vectors are obtained from a known device upgrade inventory and are similar to this affected network device vector.

In case there are sufficiently proximate vectors, the device configuration risk factor 232 is a function of the average dwell time for these vectors over the dwell time for all vectors. If there are no proximate vectors, the specific device configuration risk factor 232 is an average dwell time of all vectors. The specific device configuration risk factor 232 represents the probability of success of upgrading the device 210. The specific device configuration risk factor 232 is specific to the device 210 and may be calculated for each affected asset of the enterprise network 212, which are then aggregated to factor into the success probability of a respective remediation plan.

The remediation and risk assessment engine 120 generates the remediation plans 280a-n that may address issues identified by the diagnostic issue detection 270 and/or the anomaly detection 272, and may consider enterprise inputs on the types of issues that should be prioritized, for example based on the enterprise policy factor 230. The remediation and risk assessment engine 120 evaluates various upgrade and migration options for the enterprise network 212 based on the available upgrades information obtained from one or more data repositories and generates the remediation plans 280a-n.

For example, the remediation plans 280a-n include a first remediation plan 280a that proposes to upgrade the device 210 to version 2 242b of the operating system 240, a second remediation plan 280b that proposes to upgrade the device 210 to version n 242n of the operating system 240, and a third remediation plan 280n that proposes to migrate the device 210 to a different operating system.

Each of the remediation plans 280a-n includes an associated probability of success computed based on the one or more factors detailed above such as such as (1) code change risk factor 220, (2) network complexity factor 222 of the enterprise network 212, (3) prior outcomes factor 224, (4) enterprise context factor 226, (5) service request remediation outcome factor 228, (6) enterprise policy factor 230, and/or (7) specific device configuration risk factor 232. For example, the probability of success is computed based on other enterprises making similar changes and having similar networks and based on the level of complexity of the enterprise network 212 itself. The remediation plans 280a-n may provide details about how each of these factors contributed to the computed probability of success.

Risk estimation is based on iatrogenesis (negative side effects) likelihood. Prediction is performed on a per change element of the respective remediation plan. The remediation and risk assessment engine 120 making the prediction may be a classifier that fuses input data (telemetry data and the available software upgrade information) to generate various risk factors, and then computes the probability of success based on the risk factors. In one example embodiment, the remediation and risk assessment engine 120 is a tree-based estimator for spot-based risk estimation. In another example embodiment, the remediation and risk assessment engine 120 is a transformer or a recurrent neural network (RNN-based neural network) consuming not only input related to the current change element, but also its own estimation from previous change elements. This allows for jointly estimating the risk of an entire remediation plan.

The remediation and risk assessment engine 120 may use various information available from the enterprise service cloud 100 (telemetry data) to generate the remediation plans 280a-n. Context of the change such as embedding of command or identifier of macro-activity (such as software upgrade) may be considered. Binned statistic of change as found in service request (SR) databases, ticketing, and service system records may be considered. Change magnitude and commonality estimation based on control plane and data plane event counts may be considered. Frequency of changes for a given context (via Terminal Access Controller Access Control System (TACACS)/Remote Authentication Dial-In User Service (RADIUS) logs lookup) may be considered. System and network stress (load/resources/errors as baseline or at time of proposed change execution) may be considered. Estimation of upgrade rollback probability for upgrade from X->Y on device Z by integrating rollback probability for upgrades X->Y, *->Y, X->* may also considered. The rollback probability may be collected from Onboard Failure Logging (OBFL) when available, from syslog, from SR and other incident ticketing or troubleshooting systems. Enterprise context that includes resiliency of the enterprise network including its provisioning, redundancies, and software recovery automations.

The remediation and risk assessment engine 120 aggregates various different sources of information (telemetry data) to compute one or more risk factors noted above and applies the enterprise policy factor 230 as constraints to generate the remediation plans 280a-n and to compute their respective probabilities of success. In one example embodiment, these various risk factors may be computed by multiple different services that are executing on different systems. These computed risk factors are then provided to the risk assessment engine 120 to compute the probability of success of a candidate remediation plan.

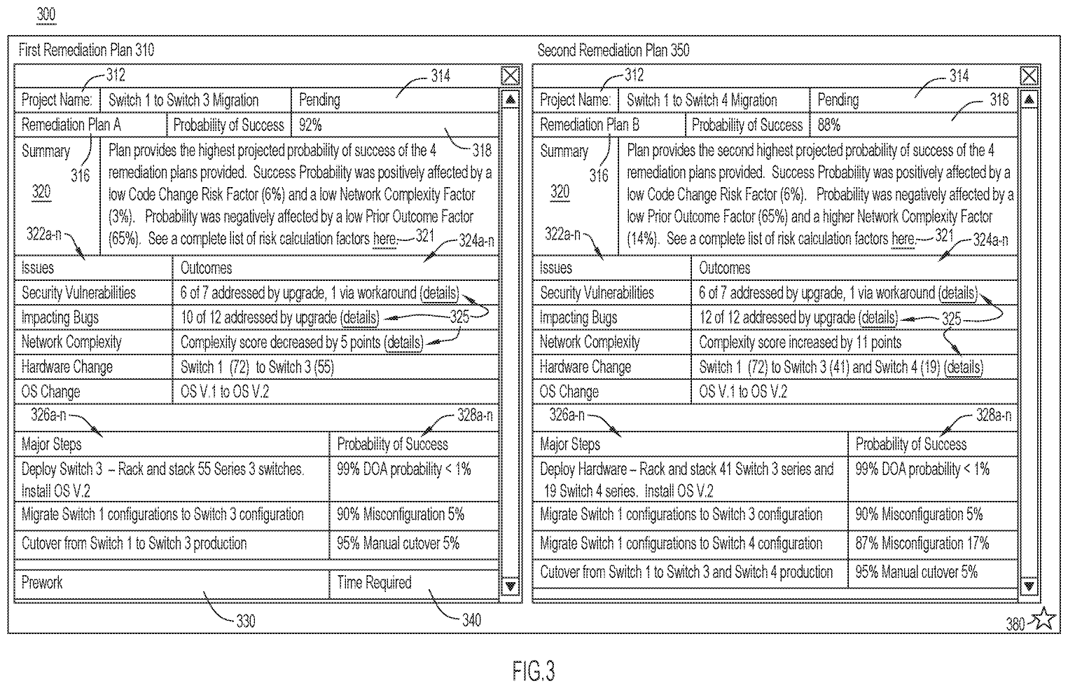

FIG. 3 is a user interface screen 300 illustrating remediation plans with respective probabilities of success, according to an example embodiment. Reference is also made to FIGS. 1 and 2 for purposes of the description of FIG. 3. The user interface screen 300 includes a first remediation plan 310, a second remediation plan 350, and an indicator 380 to select to view additional remediation plans.

Each of the first remediation plan 310 and the second remediation plan 350 includes project name 312, status 314, plan identifier 316, probability of success 318, summary 320, issues 322a-n and outcomes 324a-n. Additionally, each of the first remediation plan 310 and the second remediation plan 350 includes major steps 326a-n and probabilities of success 328a-n of the respective major steps 326a-n, preparation (prework) required 330, and time required 340. Complete list option 321 and detailed view option 325 are provided to obtain additional information about a respective portion of a remediation plan.

By way of an example, the first remediation plan 310 and the second remediation plan 350 are directed to hardware migration such that the first remediation plan 310 includes the project name 312 of Switch 1 to Switch 3 migration and the second remediation plan 350 includes the project name 312 of Switch 1 to Switch 4 migration. The status 314 indicates the state of the plan whether it is completed, in progress, or pending. The plan identifier 316 may be in a form of alphanumeric characters and uniquely identifies the respective generated remediation plan. The probability of success 318 indicates the likelihood that the migration will succeed or chances of a rollback. For example, the first remediation plan 310 has the probability of success 318 at 92% and the second remediation plan 350 has the probability of success 318 at 88%. In one example embodiment, the remediation plans may be displayed in the order of their respective probability of success 318.

The summary 320 indicates various factors that contributed to the probability of success 318. For example, the summary 320 in the first remediation plan 310 indicates that the probability of success 318 was positively affected by a low code change risk factor (6%) and a low network complexity factor (3%) and was negatively affected by a low prior outcomes factor (65%). The complete list option 321 is provided to view a complete list of risk factors and their respective contributions in computing the probability of success 318.

The issues 322a-n addressed by a respective remediation plan may include security vulnerabilities, impacting bugs, network complexity, hardware change, and operating system change. For each of the issues 322a-n, a respective outcome is provided. The outcomes 324a-n may include: (1) number of vulnerabilities addressed by the remediation plan and how these vulnerabilities are addressed, (2) number of bugs fixed, whether the network complexity is decreased or increased using a point value system that ranks the network complexity, (3) type and number of hardware and software changes needed. Detailed view option 325 is provided to view a respective outcome in further detail.

Each of the first remediation plan 310 and the second remediation plan 350 includes major steps 326a-n to be performed and their respective probabilities of success 328a-n. For example, major steps 326a-n may include deploying switches and the number of switches to deploy, installing a software update such as operating system change, migrating configuration of various hardware, switching over production to the newly installed and configured assets. The probabilities of success 328a-n may further include reasons for the computed probability such as chances of obtaining a faulty hardware (dead on arrival—DOA), chances of misconfiguration, and chances of needing a manual cutover.

Each of the first remediation plan 310 and the second remediation plan 350 includes prework 330 such as the number and type of hardware components needed, the software or repository where the new software can be obtained, etc. The time required 340 includes time to allocate for performing the respective remediation plan.

Based on a selection of a particular plan, the enterprise service cloud 100 performs a change in the configuration of one or more assets of an enterprise network such as updating the operating system on the device 210 of the enterprise network 212.

There are multiple software upgrade options available to enterprises when they decide to upgrade or migrate assets in their networks. Each software upgrade has benefits and risks that can influence enterprise's decision. The remediation and risk assessment engine 120 utilizes information about the enterprise network or telemetry data associated with a respective enterprise network that includes a number of assets involved in providing various enterprise services and available software upgrade information, and prior outcomes information, to generate different remediation plans and to calculate their respective risks, thereby aiding enterprises in making their remediation plan decisions. In one example embodiment, the remediation and risk assessment engine 120 computes a number of risk factors and transforms them into an overall probability of success for each remediation plan being considered using neural networks or tree-based estimations.

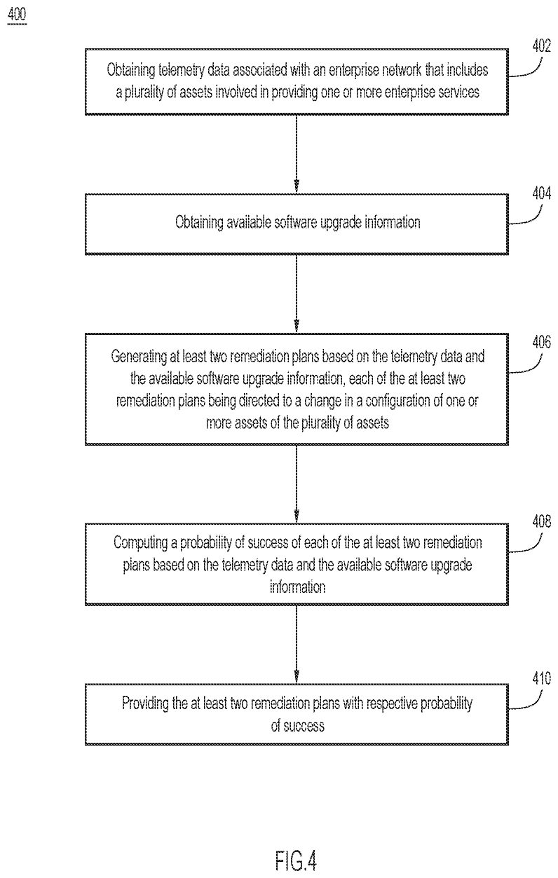

FIG. 4 is a flowchart illustrating a computer-implemented method 400 of providing at least two remediation plans with respective probabilities of success, according to an example embodiment. The method 400 may be implemented by one or more computing devices such as servers or the remediation and risk assessment engine 120 of FIGS. 1 and 2.

At 402, the computer-implemented method 400 involves obtaining telemetry data associated with an enterprise network that includes a plurality of assets involved in providing one or more enterprise services.

At 404, the computer-implemented method 400 involves obtaining available software upgrade information.

At 406, the computer-implemented method 400 involves generating at least two remediation plans based on the telemetry data and the available software upgrade information. Each of the at least two remediation plans is directed to a change in a configuration of one or more assets of the plurality of assets.

At 408, the computer-implemented method 400 involves computing a probability of success of each of the at least two remediation plans based on the telemetry data and the available software upgrade information.

At 410, the computer-implemented method 400 involves providing the at least two remediation plans with a respective probability of success.

In one form, the computer-implemented method 400 may further include making a selection of one of the at least two remediation plans and performing the change in the configuration of the one or more assets based on the selection.

In one instance, the computer-implemented method 400 may further involve computing a prior outcome factor for each of the at least two remediation plans, based on a plurality of success rates of a respective remediation plan implemented by other enterprise networks. The operation 408 of computing the probability of success of each of the at least two remediation plans may further be based on the prior outcome factor.

In another form, the operation 408 of computing the probability of success of each of the at least two remediation plans may further include computing a rollback probability of each of the at least two remediation plans based on the telemetry data that may include one or more incident reports or one or more open troubleshooting cases with respect to the change in the configuration.

In the computer-implemented method 400, the available software upgrade information includes data related to a nature of and reason for an available software upgrade. The computer-implemented method may further include determining a degree of code change of the available software upgrade with respect to a current software version executing on the one or more assets. The operation 408 of computing the probability of success of each of the at least two remediation plans may include computing the probability of success of the available software upgrade based on the telemetry data, the available upgrade information, and the degree of code change.

According to one or more example embodiments, the computer-implemented method 400 may further involve evaluating a complexity of the enterprise network based on the telemetry data including one or more of: number and types of network technologies deployed in the enterprise network, number and types of the plurality of assets that are affected by an available software upgrade, and deployment architecture of the enterprise network. The operation 406 of generating the at least two remediation plans and the operation 408 of computing the probability of success of each of the at least two remediation plans may further be based on the complexity of the enterprise network.

In one instance, the computer-implemented method 400 may further involve evaluating an enterprise context based on the telemetry data including one or more of: one or more configuration issues present in the enterprise network, one or more anomalies detected in the enterprise network, and resiliency of the enterprise network based on provisioning of the enterprise network, redundancies that exist in the enterprise network, and software recovery automations. The operation 406 of generating the at least two remediation plans and the operation 408 of computing the probability of success of each of the at least two remediation plans may further be based on the enterprise context.

According to one or more example embodiments, the operation 408 of computing the probability of success of each of the at least two remediation plans may include computing a success probability of a software upgrade for each affected network device of the plurality of assets by performing the following operations. Based on a hardware and software configuration for each affected network device, computing an affected network device vector that represents the hardware and software configuration of a respective affected network device. The operations further include obtaining, from a known device upgrade inventory, at least one other vector that is similar to the affected network device vector and computing the success probability of the software upgrade for the respective affected network device based on the at least one other vector. The operation 408 of computing the probability of success of each of the at least two remediation plans may further include aggregating the success probability of the software upgrade for each affected network device to compute the probability of success of a respective remediation plan.

According to one or more example embodiments, the operation 406 of generating the at least two remediation plans may further include obtaining an enterprise policy that relates to performing changes in configurations of the plurality of assets. The enterprise policy including one or more security rules for performing the changes in the configurations, configuration type rules related to types of configuration changes permitted, and timing rules related to when to perform the configuration changes. The operation 406 of generating the at least two remediation plans may further include selecting the at least two remediation plans from a plurality of remediation plans based on the enterprise policy.

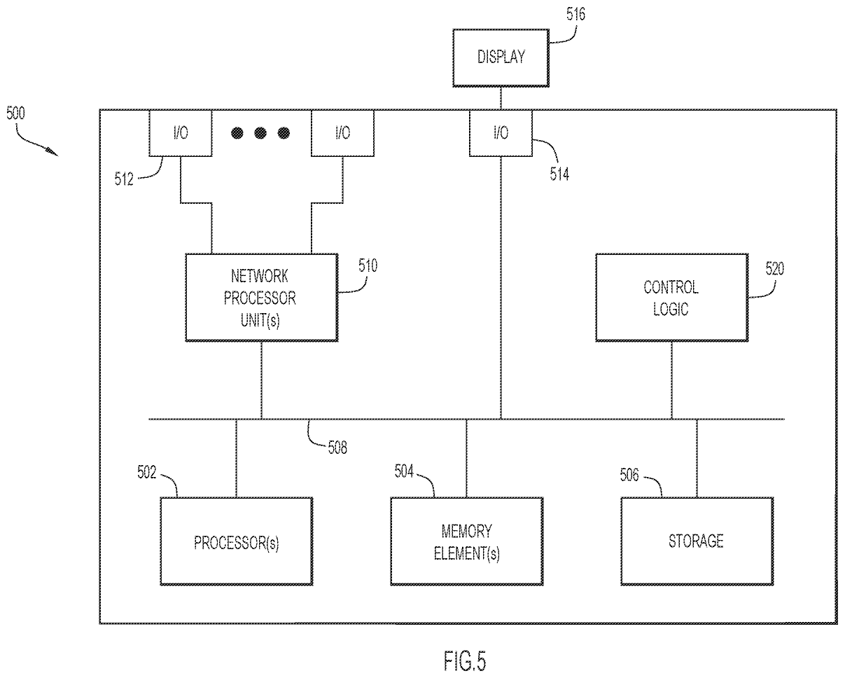

FIG. 5 is a hardware block diagram of a computing device 500 that may perform functions associated with any combination of operations in connection with the techniques depicted and described in FIGS. 1-4, including, but not limited to, operations of the computing device or one or more servers that execute the enterprise service cloud 100. Further, the computing device 500 may be representative of one of the network devices. It should be appreciated that FIG. 5 provides only an illustration of one embodiment and does not imply any limitations with regard to the environments in which different embodiments may be implemented. Many modifications to the depicted environment may be made.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with one or more memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to the computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 516, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided such as the remediation and risk assessment engine 120 of FIGS. 1 and 2. The apparatus includes a memory, a network interface configured to enable network communications, and a processor. The processor is configured to perform various operations. The operations include obtaining telemetry data associated with an enterprise network that includes a plurality of assets involved in providing one or more enterprise services, obtaining available software upgrade information, and generating at least two remediation plans based on the telemetry data and the available software upgrade information. Each of the at least two remediation plans is directed to a change in a configuration of one or more assets of the plurality of assets. The operations further include computing a probability of success of said each of the at least two remediation plans based on the telemetry data and the available software upgrade information and providing the at least two remediation plans with a respective probability of success.

In yet another example embodiment, one or more non-transitory computer readable storage media encoded with instructions are provided. When the media is executed by a processor, the instructions cause the processor to execute a method involving obtaining telemetry data associated with an enterprise network that includes a plurality of assets involved in providing one or more enterprise services, obtaining available software upgrade information, and generating at least two remediation plans based on the telemetry data and the available software upgrade information. Each of the at least two remediation plans is directed to a change in a configuration of one or more assets of the plurality of assets. The method further involves computing a probability of success of said each of the at least two remediation plans based on the telemetry data and the available software upgrade information and providing the at least two remediation plans with the respective probability of success.

In yet another example embodiment, a system is provided that includes the devices and operations explained above with reference to FIGS. 1-5.

The programs described herein (e.g., control logic 520) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 506 and/or memory elements(s) 504 can store data, software, code, instructions (e.g., processor instructions), logic, parameters, combinations thereof, and/or the like used for operations described herein. This includes the storage 506 and/or memory elements(s) 504 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of,’ one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining telemetry data associated with an enterprise network that includes a plurality of assets involved in providing one or more enterprise services;
obtaining available software upgrade information;
generating at least two remediation plans based on the telemetry data and the available software upgrade information, each of the at least two remediation plans being directed to a change in a configuration of one or more assets of the plurality of assets;
computing a probability of success of each of the at least two remediation plans based on the telemetry data and the available software upgrade information; and
providing the at least two remediation plans with a respective probability of success.

2. The computer-implemented method of claim 1, further comprising:
making a selection of one of the at least two remediation plans; and
performing the change in the configuration of the one or more assets based on the selection.

3. The computer-implemented method of claim 1, further comprising:
computing a prior outcomes factor for each of the at least two remediation plans, based on a plurality of success rates of a respective remediation plan implemented by other enterprise networks,
wherein computing the probability of success of each of the at least two remediation plans is further based on the prior outcomes factor.

4. The computer-implemented method of claim 1, wherein computing the probability of success of each of the at least two remediation plans includes:
computing a rollback probability of each of the at least two remediation plans based on the telemetry data that includes one or more incident reports or one or more open troubleshooting cases with respect to the change in the configuration.

5. The computer-implemented method of claim 1, wherein the available software upgrade information includes data related to a nature of and reason for an available software upgrade and further comprising:
determining a degree of code change of the available software upgrade with respect to a current software version executing on the one or more assets,
wherein computing the probability of success of each of the at least two remediation plans includes computing the probability of success of the available software upgrade based on the telemetry data, the available software upgrade information, and the degree of code change.

6. The computer-implemented method of claim 1, further comprising:
evaluating a complexity of the enterprise network based on the telemetry data including one or more of:
number and types of network technologies deployed in the enterprise network,
number and types of the plurality of assets that are affected by an available software upgrade, and
deployment architecture of the enterprise network,
wherein generating the at least two remediation plans and computing the probability of success of each of the at least two remediation plans is further based on the complexity of the enterprise network.

7. The computer-implemented method of claim 1, further comprising:
evaluating an enterprise context based on the telemetry data including one or more of:
one or more configuration issues present in the enterprise network,
one or more anomalies detected in the enterprise network, and
resiliency of the enterprise network based on provisioning of the enterprise network, redundancies that exist in the enterprise network, and software recovery automations,
wherein generating the at least two remediation plans and computing the probability of success of each of the at least two remediation plans is further based on the enterprise context.

8. The computer-implemented method of claim 1, wherein computing the probability of success of each of the at least two remediation plans includes:
computing a success probability of a software upgrade for each affected network device of the plurality of assets by:
based on a hardware and software configuration for each affected network device, computing an affected network device vector that represents the hardware and software configuration of a respective affected network device,
obtaining, from a known device upgrade inventory, at least one other vector that is similar to the affected network device vector, and
computing the success probability of the software upgrade for the respective affected network device based on the at least one other vector; and
aggregating the success probability of the software upgrade for each affected network device to compute the probability of success of a respective remediation plan.

9. The computer-implemented method of claim 1, wherein generating the at least two remediation plans includes:
obtaining an enterprise policy that relates to performing changes in configurations of the plurality of assets, the enterprise policy including one or more security rules for performing the changes in the configurations, configuration type rules related to types of configuration changes permitted, and timing rules related to when to perform the configuration changes; and
selecting the at least two remediation plans from a plurality of remediation plans based on the enterprise policy.

10. An apparatus comprising:
a memory;
a network interface configured to enable network communications; and
a processor, wherein the processor is configured to perform operations comprising:
obtaining telemetry data associated with an enterprise network that includes a plurality of assets involved in providing one or more enterprise services;
obtaining available software upgrade information;
generating at least two remediation plans based on the telemetry data and the available software upgrade information, each of the at least two remediation plans being directed to a change in a configuration of one or more assets of the plurality of assets;
computing a probability of success of each of the at least two remediation plans based on the telemetry data and the available software upgrade information; and
providing the at least two remediation plans with a respective probability of success.

11. The apparatus of claim 10, wherein the processor is further configured to perform:
making a selection of one of the at least two remediation plans; and
performing the change in the configuration of the one or more assets based on the selection.

12. The apparatus of claim 10, wherein the processor is further configured to perform:
computing a prior outcomes factor for each of the at least two remediation plans, based on a plurality of success rates of a respective remediation plan implemented by other enterprise networks,
wherein the processor is configured to compute the probability of success of each of the at least two remediation plans further based on the prior outcomes factor.

13. The apparatus of claim 10, wherein the processor is configured to compute the probability of success of each of the at least two remediation plans by:
computing a rollback probability of each of the at least two remediation plans based on the telemetry data that includes one or more incident reports or one or more open troubleshooting cases with respect to the change in the configuration.

14. The apparatus of claim 10, wherein the available software upgrade information includes data related to a nature of and reason for an available software upgrade and the processor is further configured to perform:
determining a degree of code change of the available software upgrade with respect to a current software version executing on the one or more assets,
wherein the processor is configured to compute the probability of success of each of the at least two remediation plans by computing the probability of success of the available software upgrade based on the telemetry data, the available software upgrade information, and the degree of code change.

15. The apparatus of claim 10, wherein the processor is further configured to perform:
evaluating a complexity of the enterprise network based on the telemetry data including one or more of:
number and types of network technologies deployed in the enterprise network,
number and types of the plurality of assets that are affected by an available software upgrade, and
deployment architecture of the enterprise network,
wherein the processor is configured to generate the at least two remediation plans and to compute the probability of success of each of the at least two remediation plans further based on the complexity of the enterprise network.

16. The apparatus of claim 10, wherein the processor is further configured to perform:
evaluating an enterprise context based on the telemetry data including one or more of:
one or more configuration issues present in the enterprise network,
one or more anomalies detected in the enterprise network, and
resiliency of the enterprise network based on provisioning of the enterprise network, redundancies that exist in the enterprise network, and software recovery automations,
wherein the processor is configured to generate the at least two remediation plans and compute the probability of success of each of the at least two remediation plans further based on the enterprise context.

17. One or more non-transitory computer readable storage media encoded with instructions that, when executed by a processor, cause the processor to execute a method comprising:
obtaining telemetry data associated with an enterprise network that includes a plurality of assets involved in providing one or more enterprise services;
obtaining available software upgrade information;
generating at least two remediation plans based on the telemetry data and the available software upgrade information, each of the at least two remediation plans being directed to a change in a configuration of one or more assets of the plurality of assets;
computing a probability of success of each of the at least two remediation plans based on the telemetry data and the available software upgrade information; and
providing the at least two remediation plans with a respective probability of success.

18. The one or more non-transitory computer readable storage media of claim 17, wherein the method further comprises:
making a selection of one of the at least two remediation plans; and
performing the change in the configuration of the one or more assets based on the selection.

19. The one or more non-transitory computer readable storage media of claim 17, wherein the method further comprises:
computing a prior outcome factor for each of the at least two remediation plans, based on a plurality of success rates of a respective remediation plan implemented by other enterprise networks,
wherein computing the probability of success of each of the at least two remediation plans is further based on the prior outcome factor.

20. The one or more non-transitory computer readable storage media of claim 17, wherein computing the probability of success of each of the at least two remediation plans includes:
computing a rollback probability of each of the at least two remediation plans based on the telemetry data that includes one or more incident reports or one or more open troubleshooting cases with respect to the change in the configuration.
